(19) United States
(12) Patent Application Publication
(10) Pub. No.: US 2019/0275928 A1
(43) Pub. Date: Sep. 12, 2019

(54) DDMS (Driver to driver messaging system)

(71) Applicant: Andre De La Rey Rossouw, Hermitage, TN (US)

(72) Inventor: Andre De La Rey Rossouw, Hermitage, TN (US)

(21) Appl. No.: 16/183,580

(22) Filed: Nov. 7, 2018

Related U.S. Application Data
(60) Provisional application No. 62/639,304, filed on Mar. 6, 2018.

(51) Int. Cl. B60Q 1/50; B60R 11/02

(52) U.S. Cl. CPC B60Q 1/503; B60R 2011/004; B60R 11/0229

(57) ABSTRACT

A visual observation by a “trailing vehicle's” driver, that observes text messages illuminating from an encased unit that operates automatically and installed to the rear outside of a “followed vehicle, or the visual observation of text messages being incorporated into the “followed vehicle's” design. The text messages being observed nevertheless faces the “trailing vehicle's” driver and cautions the “trailing vehicle's” driver via the illuminating text messages to alter his/her vehicle's attitude to that of a lawful requirements, in order to drive safely. In specific but not limited to, the unit or system's function is to prevent drivers “following too close”, forgetting HIGH BEAMS on, or forgetting to TURN HEAD LIGHTS on. Other informative text messages may also be incorporated to this specific method.

### NOTE

(a) A “followed vehicle” for the purposes of this description is a vehicle traveling directly in FRONT of a “trailing vehicle”.
(b) A “trailing vehicle” is a vehicle traveling directly BEHIND a “followed vehicle”.
(c) The “system” is the measure by which the invention operates.
(d) The “unit” is the physical casing combined with the incorporated “system”.
(e) A “unit” is not the only measure by which the “system” may be incorporated. The “system” could also be incorporated as part of a vehicle's makeup, ie: the body and/or the vehicle's wiring system, especially so with new car designs.

### TECHNICAL FIELD

A visual observation by a “trailing vehicle's” driver, that observes text messages illuminating from an encased unit that operates automatically and installed to the rear outside of a “followed vehicle, or the visual observation of text messages being incorporated into the “followed vehicle's” design using the system. The text messages being observed nevertheless faces the “trailing vehicle's” driver and cautions the “trailing vehicle's” driver via the illuminating text messages to alter his/her vehicle's attitude to that of lawful requirement/s, in order to drive safely. In specific but not limited to, the unit or system's function is to prevent drivers “following too close”, forgetting HIGH BEAMS on, or forgetting to TURN HEAL LIGHTS on by alerting them to such. More text message commands could be programmed into the unit pending full development as well as any INFORMATIVE text messages.

### BACKGROUND

Dangerous situations are created everyday by drivers following too close to followed vehicles, or forgetting to turn on headlights, or driving with high beams behind a followed vehicle, causing a blinding to not only oncoming vehicles but also to followed vehicle's. Collisions involving specifically teenagers are on the rise to the point that local officials are staging local safety awareness events for teenage drivers. Parents would WANT to keep their children safe on the road and this unit would definitely help. This unit would equally be a safety add on to school and public buses as well as big trucks. This unit could help lower insurance quotes for companies and teenage drivers. The idea could also be sold to car manufacturers to integrate during manufacturing. These units will be stylish and add on the car's appearance in a positive way and could very well become as common as brake lights, reverse lights and turn signals. Dangerous situations are mostly created in an absent minded way by drivers not realizing they are creating dangerous unsafe situations. Drivers mostly do not KNOW what a proper following distance is and this unit will help them keep at a safe distance. Most drivers also simply forget to turn on headlights or turn off high beams. Vehicles STILL use “turning signals”, “brake Tights” and “reverse lights” to safely and effectively communicate with trailing drivers to it's intentions. This system adopts the same simple method as well, being a driver does not need to take his eyes off the road as in to look at internal messages on the vehicle dashboard or any cell phone alerts. The text messages coming from the unit is straight ahead and on the vehicle in front of the trailing driver, where his eyes are supposed to be. Automated systems where vehicles take over the driving aspect to correct distance following could also be distracting and dangerous and a driver may end up “wrestling” with a vehicle to keep control of it, or denying the vehicle's “taking action” systems. These “taking action” systems can also be turned off by a driver rendering them fruitless. The system herein is simple, effective and even if things do go wrong will not create an unsafe situation. This system works WITH the human senses and is not demanding some new “sense awareness” from a driver of a vehicle as new high tech built in systems do.

### SUMMARY

This invention idea is a much simpler and safer method to help motorists determine their following distance and keeping their following distance proper. This system also alert motorists when they are creating a unsafe situation by forgetting to turn on headlights or forgetting their high beams on. This system is a much simpler method akin to other current simple methods found on a vehicles, such as “turning signals” “brake lights” and “reverse lights”. This system does not ask for additional “training” of the human brain such as many inventions do, it is simply using the same simplicity methods for which the human brain is already “trained”, and in being so would be a quick adaptation on the roads.

### ILLUSTRATIONS INDEX

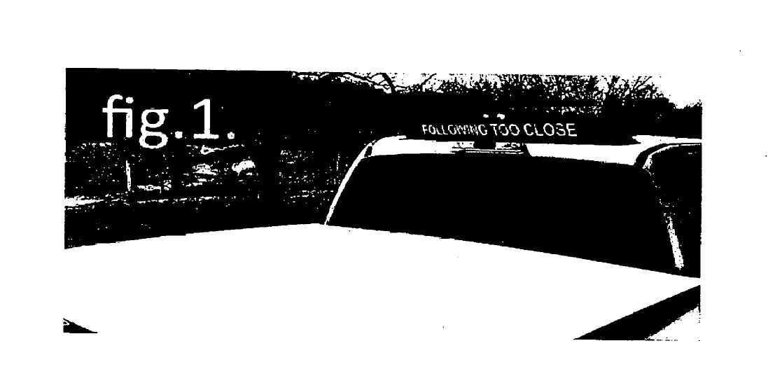

FIG. 1.

Shows UNIT installed on Pick-Up Truck.

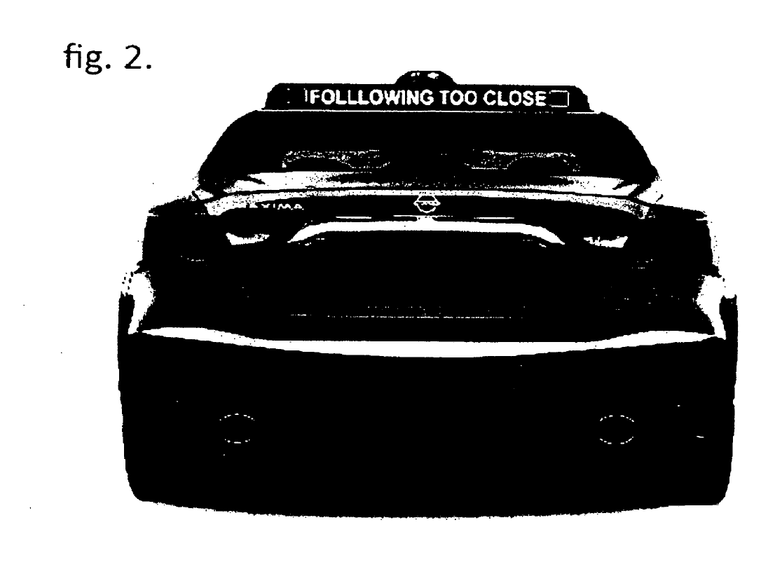

FIG. 2.

Shows UNIT installed on automobile (following too close text).

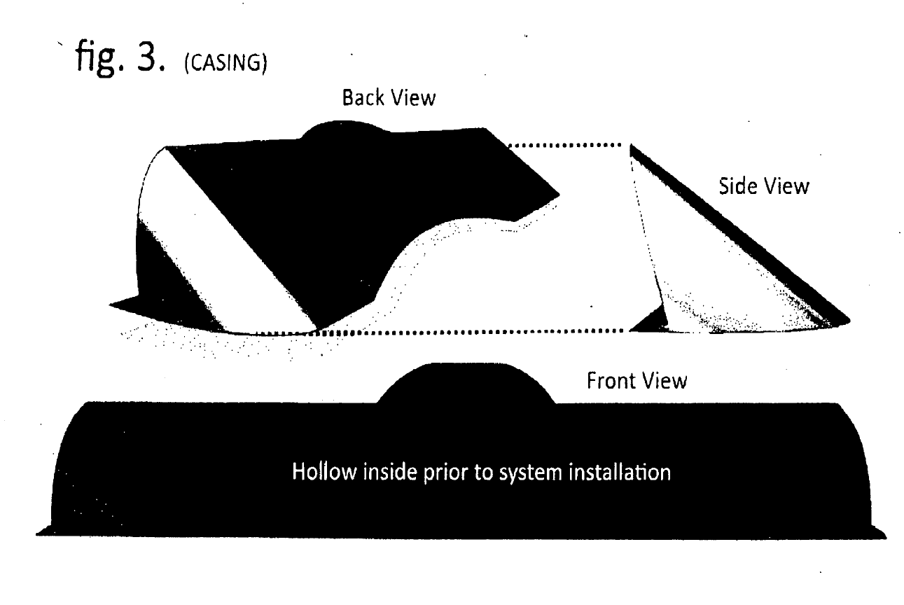

FIG. 3.

Shows UNIT CASING. (without workings).

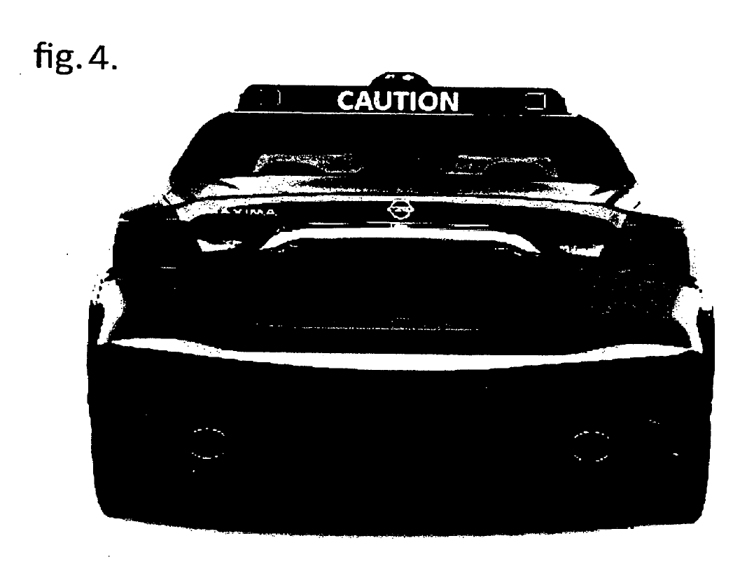

FIG. 4.

Shows UNIT installed on automobile (caution text).

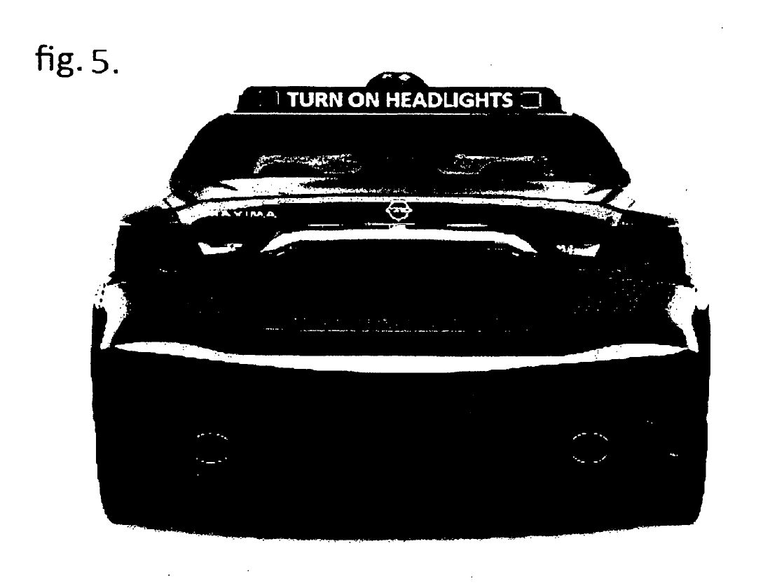

FIG. 5.

Shows UNIT installed on automobile (turn on headlights text).

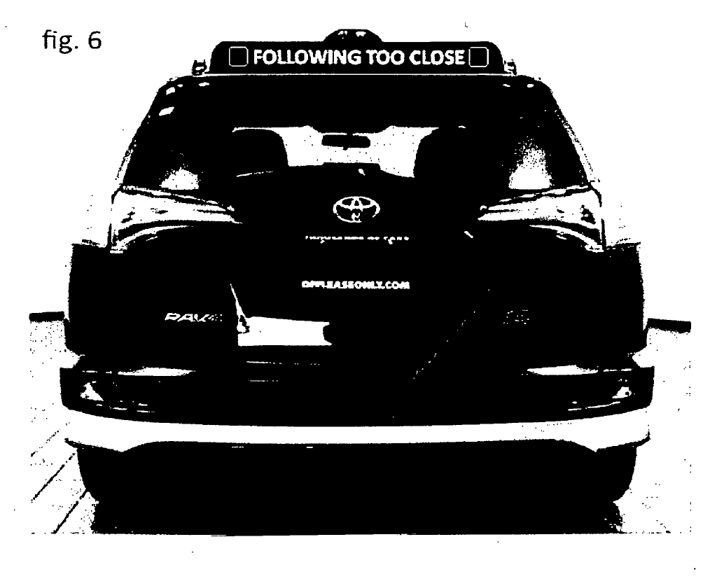

FIG. 6.

Shows UNIT installed on SUV.

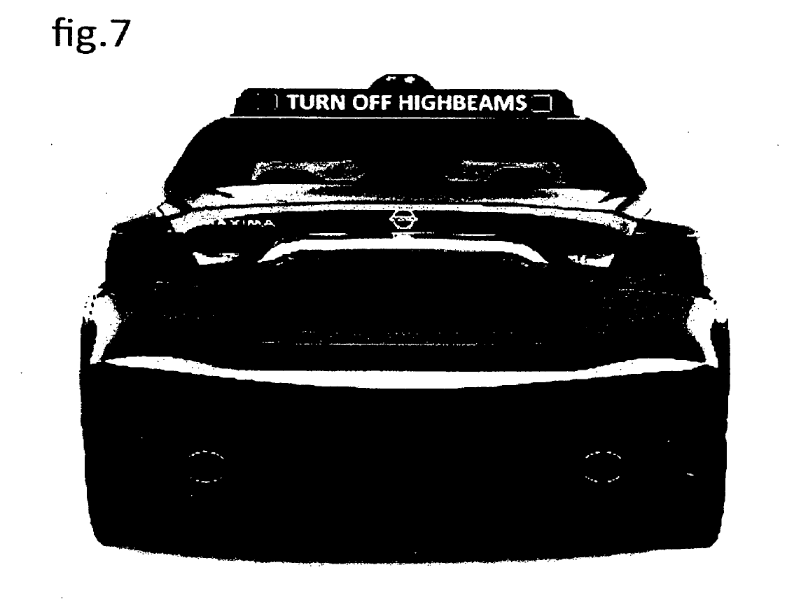

FIG. 7.

Shows UNIT installed on automobile (turn off high beams text).

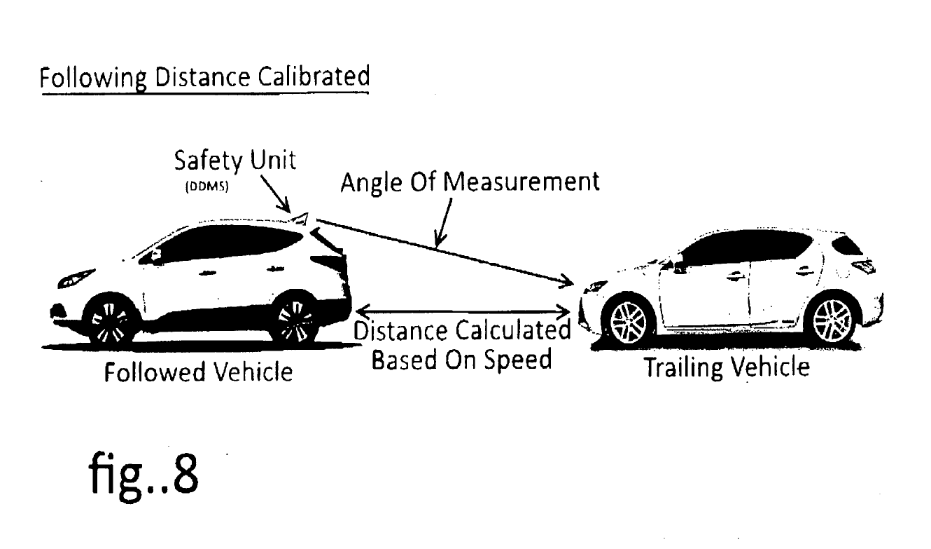

FIG. 8.

Shows Following Distance Calibrated.

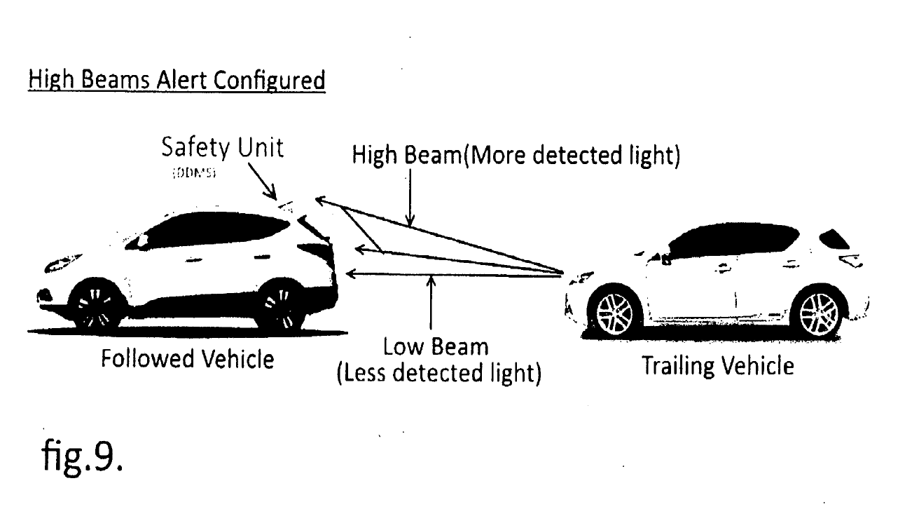

FIG. 9.

Shows High Beam/Low Beam Calibrated.

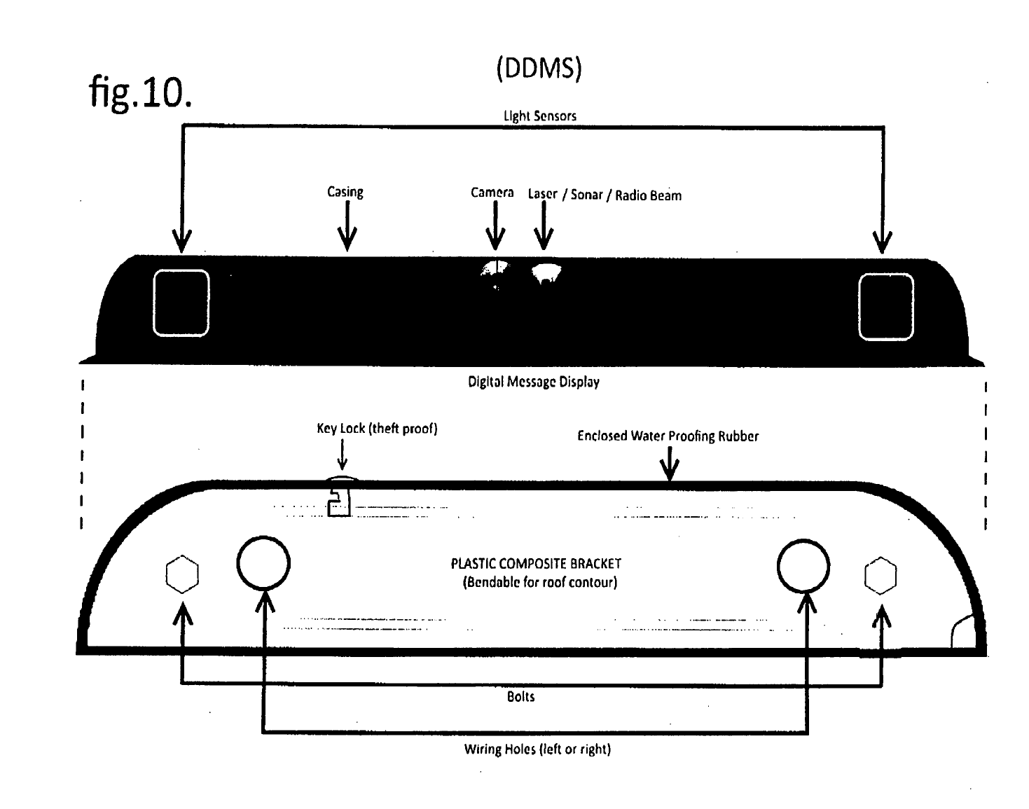

FIG. 10.

Shows Hardware (not necessarily final locations of hardware on casing).

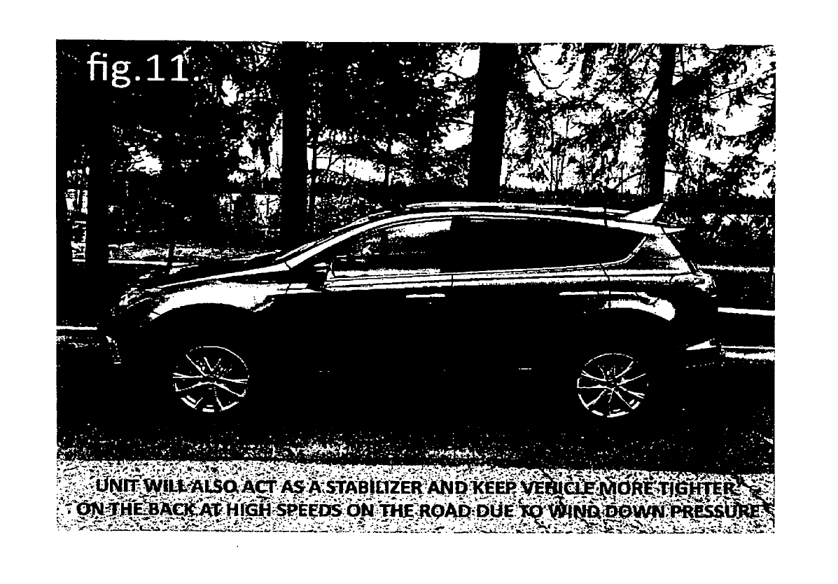

FIG. 11.

Shows Unit side view on SUV. (Also acts as keeping vehicle more secure on road due to downwind pressure).

1-29.

30. A unit installed to the rear outside of a “followed vehicle” that illuminates automated text messages to be observed by a “trailing vehicle's” driver that warns him when he follows too close or has his high beams on or has forgotten to turn his headlights on or any other informative messages pertaining to safe driving.

31. The unit incorporates a SYSTEM comprising of one or all of the following:
i) laser or radio wave to determine following distance,
ii) speed detector” that determines the speed of the “followed vehicle” constantly,
iii) a camera that records a “trailing vehicle” should it's driver refuse to adhere to the safe conditions messages emitted by the unit or system,
iv) automated software to determine the “following distance” between the “followed vehicle” and the “trailing vehicle” as well as determining whether high beams are on or no headlights are on after dark

32. The SYSTEM can be incorporated into a vehicles body design without a casing or different designs of casings may be used to house the system.
